(19) United States
(12) Patent Application Publication
(10) Pub. No.: US 2006/0251040 A1
(43) Pub. Date: Nov. 9, 2006

(54) Method for establishing a connection between a mobile station and a communication network

(76) Inventors: Gunnar Nitsche, Dresden (DE); Mathias Westendorf, Dresden (DE); Matthias Hofmann, Freital (DE)

Correspondence Address: BAKER & BOTTS, 30 ROCKEFELLER PLAZA, 44TH FLOOR, NEW YORK, NY, 10112, US

(21) Appl. No.: 10/538,312

(22) PCT Filed: Sep. 15, 2003
(86) PCT No.: PCT/DE03/03058

§ 371 Date: Oct. 14, 2005

(30) Foreign Application Priority Data
Dec. 20, 2002 (DE) 102 61 201.3

(51) Int. Cl. H04J 1/00

(52) U.S. Cl. 370/343

(57) ABSTRACT

A procedure for establishing a connection between a mobile station and a communication network through an access point involves selection of communication parameters. The procedure automatic recognizes currently available connections possibilities to various communication networks of various standards, and stores and analyzes found parameters for the standards and the establishment and maintenance of a connection with one of the found connection possibilities. The automatic recognition includes investigation of connection possibilities of networks with differing standards and frequency bands. In the procedure, a check of the connection possibilities within a first selected standard is carried out, then within a second selected standard is carried out. Parameters characterizing the standard with which a connection possibility is found are stored. A connection is established to an access point with which communication occurs using a standard after program controlled or manual selection of selection criteria.

### CROSS REFERENCE TO RELATED APPLICATIONS

This application claims the benefit of International Patent Application No. PCT/DE03/03058 filed Sep. 15, 2003, which claims priority to German Patent Application No. 102 61 201.3 filed Dec. 20, 2002, both of which applications are hereby incorporated by reference in their entireties herein.

### FIELD OF THE INVENTION

The invention relates to a method for connecting a mobile station and a communication network, in which a connection is made between the mobile station and the network after selecting connection parameters via an access point.

### BACKGROUND OF THE INVENTION

A mobile communication station may, for example, be a cordless telephone, a mobile telephone or else a computer. These mobile stations produce a connection to the respective communication network via a so-called access point. In the case of cordless telephones, the access point is the base station via which a connection is produced to the telephone network. In the case of mobile telephones, a connection is produced to the mobile radio network via a base station for a current radio cell. Similarly, a computer is connected to the Internet via, for example, a service provider's access point.

A number of methods for production of a connection, in the respective application, are known from the prior art.

A first method assists the identification of the currently used data rate in the case of modems. After selection of another network subscriber via a telephone network and after having set up a call through the selected modem, the two appliances agree important transmission parameters with one another, such as the transmission rate, error correction, data compression and the protocol that is used. Once the parameters have been agreed, the actual data transmission starts.

A further method for production of a connection is known from the field of wireless telephony. According to the DECT Standard, a mobile appliance checks all the possible transmission channels within the standard, and then selects the channel with the best reception result for setting up a connection. This method reduces the susceptibility of the transmission to interference, and at the same time improves the speech quality. This standard supports single-cell and multiple-cell systems with a soft handover between the cells.

In the case of the GSM Standard, which is used for mobile telephones, a search process is likewise carried out over the possible frequency ranges and channels before a connection is set up.

Furthermore, appliances are known which can process both the GSM Standard and the DECT Standard, covering both standards. The same applies to the field of computer networks in which a WLAN/GPRS implementation is known, in which the mobile station is set either to the WLAN Standard or to the GPRS Standard. It is not possible to change the standard during operation.

U.S. Pat. No. 5,991,287 discloses an arrangement and a method from the WLAN field, in which a search is carried out for further access points during an existing connection using a current access point, thus allowing a seamless connection handover from a first access point to a second access point within a wireless computer network.

The mobile station has a scanner unit for searching for available access points. The search is carried out in such a way that, for example, the connection quality is tested and the result of this test is used to make a decision as to whether the connection quality is above a predetermined threshold value. If the connection quality is below the threshold value, a scanning process is carried out with the aim of finding one or more available access points with better connection quality. When a search has been carried out successfully, the connection is set up with the access point that has been found, once the connection with the old access point has been cleared. The communication between the mobile station and the access point is controlled by appropriate signal management which prevents any loss of data within the time of the scanning process, for example in accordance with the IEEE 802.11 protocol.

The known methods predominantly allow a connection to be set up between the mobile station and the communication network within one standard or in a one-off selection between standards of related types. Both the transmission type and the access method and the modulation type are the same for GSM and DECT. A connection is thus selected which cannot be the connection with the best-possible data transmission rate for the current location of the mobile station. Furthermore, in the case of WLAN/GPRS by way of example, it is necessary to define before starting the system the standard which will be used to set up a connection. When the current connection is interrupted, it is first of all necessary to search for a possible access point and then to produce the connection to this access point, which takes a certain amount of time.

European Patent publication No. EP 1 257141 A1 discloses a method and an arrangement for dynamic system power adaptation (DSPA) in particular DSPA in between radio access networks which use different radio access technologies or protocols.

European Patent publication No EP 1 257141 A1 provides an arrangement and a method for operation of at least one first and one second mobile long-distance transmission network, which are connected via at least one common node. A mobile data station which is located in the area of the first network has set up an active connection to this network. The mobile data station is able to scan the frequency spectrum, and to identify other possible radio access networks. The result of this scanning process is transmitted from the mobile data station to the access node of its network.

The mobile data station sends a message to its first long-distance transmission network with a request for a specific mobile long-distance transmission network service. Within the first network, the scanning report is used as the basis for deciding which of the radio networks found during the scanning process is suitable for the requested service. The first radio network then checks with the common node as to whether at least a portion of the communication can be carried out with the mobile data station via the second network.

This solution has the disadvantage of the necessity for a common node for different radio networks, the necessity for an existing data connection from a mobile station to a radio network, and the central decision about a connection option to be used.

Consideration is now being given to methods which provide versatility in providing connections in communication systems that are diverse or involve multiple standards. In particular attend is paid to developing connection methods in which connection options that can currently be used to different communication networks using different standards are identified automatically, the parameters relating to the standards that have been found are stored and assessed, and a connection is set up and maintained using one of the connection options that have been found by a mobile station.

### SUMMARY OF THE INVENTION

The invention provides methods in which setting up a connection to an access point is carried out by the mobile station on the basis of selection criteria under program control or by manual selection. The access points may be of the type with which communication takes place via one standard and for which a connection option has been found.

After switching on or rebooting a mobile station, it carries out a search for the available connection options. To do this, all of the connection standards which are known to the mobile station and can be updated at any time are selected successively. Once the first standard has been selected, a check of the connection options is carried out within this standard by, for example, successively checking all of the channels at a first carrier frequency for the DECT Standard before a second carrier frequency for the DECT Standard is selected, and all of the associated channels are checked once again. The test may be carried out actively, by transmission of a signal and evaluation of the received response, or passively just by evaluating the reception. After completion of the search within the first standard, the assemblies which are required for setting up a connection based on a specific standard are selected under program control or by rebooting to the second standard to be checked, and the search is continued within this standard. The possible standards include, for example, IEEE 802.11 a/b/g, HiperLAN/2, Bluetooth and GPRS. For each search run, parameters such as the standard designation, frequency band, carrier frequency, channel, result of the connection test and others are stored, in which case the data storage may also be restricted to the parameters for the options with which a connection has been found. The stored data can then be subjected to an assessment process. The assessment criteria may be, for example, the connection speed, the data throughput, the signal strength or the costs for the connection. A connection is then set up to an access node either under program control by means of selected preset parameters, or once the user has made a selection from a list of the available connection options.

One embodiment of the invention provides that the connection is set up using the connection option which achieves the maximum data throughput.

The data which is stored during the search for connection options offers the capability to carry out an assessment, for example, with regard to the transmission speed of the standard that has been found. During the assessment process, the effectively achievable data rate can also be taken into account, or what useful data can still be transmitted after subtraction of the preamble, header and CRC data in a WLAN packet. A further option is to assess the signal strength, since this makes it possible to deduce the probability of a data transmission with errors and the effective data rate to be expected, bearing in mind the necessity to retransmit the incorrectly transmitted packet.

One advantageous embodiment of the invention provides for the identification and the data storage to be carried out before logging on with an access point.

Once the mobile station has been switched on or booted, the identification process is carried out, since this represents the basis for setting up a connection to an access point. If this first identification process does not result in any connection option having been found, a second identification process is and if required further additional processes are started directly following the first, or after lapse of a preset time.

A further advantageous embodiment of the invention provides for the identification and the data storage to be carried out while a connection exists to an access point.

Once a first identification process has been carried out after the mobile station has been switched on, the connection is set up to an access point. The quality of the existing connection may change as a result of a change in the position of the mobile station with respect to the current access point and/or as a result of interference. Since, however, the aim is to provide a reliable connection to the communication network for the user of the mobile station, it is necessary to end the connection to the current access point, and to set up a connection to a new access point. A further identification process is also carried out within the time period of an active connection in order to reduce the time without any connection while switching to a different access point. When it is necessary to change a connection, the mobile station can therefore make use of current data for alternative connections.

One particular embodiment of the invention provides for the current access point to be signaled before the identification process is carried out, that the mobile station cannot receive any data for an agreed time, and arriving data is buffered in the access point.

A mobile station which is equipped with only one transmission, reception and associated data processing assembly cannot transmit any data to the access point, or receive any data from it, while an identification process is taking place. For this reason, as is normal in the WLAN Standard, the mobile station transmits a message to the current access point about the intention and the duration of the interruption in the connection. This ensures that any data which may arrive during the time of the identification process is stored by the access point, and is transmitted to the mobile station once the connection has been resumed.

A further embodiment of the invention provides that the mobile station logs off the current access point, which is carrying out the identification process, before the identification process is carried out, and that the mobile station logs on with the same access point or with another access point after the completion of the identification process.

Once again, this variant ensures that no data loss occurs during the transmission between the mobile station and the access point. After logging off from the current access point, the mobile station carries out the identification process and the updating of the stored data. A connection to an access point is then produced once again, under program control or by means of a manual selection.

One particular embodiment of the invention provides for the identification and the data storage or updating, for which parameters which identify the standard of a connection option which has been found in a subsequent identification process are stored, to be carried out within a time period in which no data is transmitted, and the mobile station is not busy carrying out other processes, which it may not be possible to interrupt.

In this situation, the identification process is carried out in the power management cycle. The advantage of using the power management cycle is, on the one hand, that no data is transmitted within this time, and on the other hand the mobile station is not busy carrying out other processes, which it may not be possible to interrupt.

A further refinement of the invention provides for the identification and the data storage or updating, for which parameters which identify the standard for a connection option for a subsequent identification process are stored, to be carried out periodically.

The first identification process which is carried out after switching on or booting the mobile station stores data relating to the individual checked and/or found connection options in a memory in the mobile station. A subsequent identification process overwrites or updates the stored data. Periodic identification of the connection options in conjunction with the storage of the data makes it possible to change to another access point within or outside the most recently used standard in the event of a deterioration in the transmission quality or a connection failure to the current access point, without the complexity of carrying out another identification process. This minimizes the time without any connection.

One advantageous embodiment of the invention provides for the identification of usable connection options to be carried out by transmission of a signal to possible access points and by evaluation of the received signal, or just by evaluation of the received signal.

The expression active identification means the transmission of a signal to possible access points, and waiting for a response. In the case of passive identification, on the other hand, only the received signal is evaluated.

One advantageous refinement of the invention provides for the identification process to be carried out in a data transmission pause during an active connection to the access point.

By way of example, the mobile station is connected via an access point to the Internet. In most cases, more data is loaded from the network to the mobile station than vice versa. This means that, once the data from a specific side has been loaded, this is set up, and the user is himself busy looking through this for some time before any further request for data transmission occurs. This pause in the data transmission is used by the method according to the invention in order to carry out an identification process.

A further advantageous embodiment of the invention provides that in the event of a deterioration in the transmission quality or a connection failure to the current access point, a change is made to an access point which ensures a better transmission quality, after accessing the stored data or another identification process.

In the event of a deterioration in the transmission quality or a connection failure, the method according to the invention provides for the connection to the connecting network to be maintained by changing the current access point. In this case, the mobile station accesses the stored data for the connection options that have been found, and can thus set up a connection to another access point in a very short time, even if this is operating using a different type of standard to the most recent current standard. At this point, the connection can likewise be made on the basis of preset parameters under program control, or on the basis of manual selection. If no more stored data is available or the stored data is no longer up to date, then it is also possible at this point to start an identification process and then to set up a new connection.

One specific embodiment of the invention provides that the switching to different standards and frequency bands is carried out under program control or by rebooting a processor.

The mobile station can be set to a desired standard while the appliance is being booted up. A corresponding protocol is provided for this purpose for each standard to be checked, and can be upgraded, deleted, adapted or supplemented by a further protocol in the event of changes in the state of the art. A further variant for switching to a standard is control by a program procedure.

A further embodiment of the invention provides that a periodic comparison is carried out between the connection parameters to the current access point and other connection options, and that a change is made to another connection option automatically or manually.

The mobile station carries out identification processes periodically.

This means that up to date data relating to identified connection options is always available, even if the position of the mobile station changes or in the event of interference. This data is assessed using predetermined parameters, and is compared with the connection to the current access point. If, for example, the mobile station finds that an access point with a higher data transmission rate or a better quality can now be accessed, the mobile station changes to another access point automatically, or after a check, during operation.

Further features of the invention, its nature, and various advantages will be more apparent from the following detailed description with reference to an exemplary embodiment.

### DETAILED DESCRIPTION OF THE INVENTION

In an implementation of the invention, an exemplary mobile station is embodied by a portable computer which is located in a WLAN network environment. The mobile station is switched on, and is set to the IEEE Standard 802.11a once the boot-up process has been mcompleted. Once this first standard has been selected, the mobile station starts to automatically identify usable connection options within the selected standard. All the parameters which identify the standard are stored by the mobile station. If this amount of data is not desirable, the storage of the parameters can be reduced to that for the “usable connection options”. The second standard, for example IEEE 802.11b, is then selected and a second search is carried out for connection options within this standard, with associated storage of the data. This process of selection of a standard and searching for associated connection options is continued until all of the standards that are known to the mobile station have been checked. The mobile station then assesses the data for the identified connection options on the basis of the preset parameter of the data transmission rate, and automatically produces a connection to the access point, which allows the highest data transmission rate. If the mobile station user has deactivated the selection of the automatic connection production, a selection list of the connection options which is arranged in the order of data transmission rates is displayed to the user. After the user has selected a connection option, the mobile station logs on with the access point which supports the selected connection option. The log-on is followed by communication with the network in the manner known from the prior art.

A deterioration in the transmission quality can occur, for example, during operation as a result of a change in the position of the mobile station with respect to the current access point. It is then necessary to end the connection to the current access point and to set up a connection again to another newly selected access point. In order to allow the mobile station to access up to date data about connection options in this situation, a periodic identification process is carried out not only before the production of a connection but also during the time period of an existing connection. In the event of any deterioration in the transmission quality or the break down of the connection, a change can thus be made within a very short time to another known access point in the network, or to another network. It is thus not only possible to change the access point within a network, but also to change the standard that is used for communication. If no up to date data is available, it is also possible to change to an appropriate access point after another identification process.

In order to carry out an identification process periodically, it is possible for the mobile station to signal to the access point that it is not possible to receive data for an agreed time, and for the access point to store any data packets that arrive. Within these agreed time windows, the mobile station carries out another automatic identification of usable connection options, and stores the data obtained in the process. Furthermore, it is possible to overwrite the entire data record, or to update only selected data items.

A second possible way to carry out another search is for the mobile station to log off from the current access point, to carry out the identification process, and for the mobile station to log on again with the same access point, or with another access point. The decision on the access point to be used is made after evaluation of the connection options that have been found, on the basis of preset parameters, or by manual selection.

An identification process can also advantageously be carried out in the power management cycle, since no data need be transmitted within this cycle. These options make it possible to ensure periodic identification and, associated with this, updating of the data relating to connection options.

The up to date database allows the mobile station to carry out a periodic comparison between the parameters for the connection to the current access point and the connection options that have been found. If the result of this comparison indicates that a connection with improved parameters is possible via another access point, the mobile station changes to the other access point automatically or after confirmation by the user. A change to another standard can also be carried out in this case. For example, the mobile station could log on in a GPRS network in the event of failure of a WLAN. This procedure ensures an optimum connection quality for the user.

1.-13. (canceled)

14. A method for production of a connection between a mobile station and a communication network, comprising the steps of:
automatically performing identification processes which identify usable connection options to different networks having different standards and frequency bands, wherein a first standard is selected and a check is carried out of the usable connection options within this first standard, then a next standard is selected and a check is carried out of the usable connection options within this next standard, and wherein connection parameters which identify the standard with which a usable connection option is found are stored;
selecting a usable connection option; and
setting up a connection from the mobile station to the network via an access point after selection of connection parameters, wherein the connection is set up by the mobile station to the access point which is being communicated to via the standard for which the usable connection option has been selected.

15. The method of claim 14 wherein selecting a usable connection option comprises selection under program control 16. The method of claim 14 wherein selecting a usable connection option comprises manual selection.

17. The method as claimed in claim 14 wherein selecting a usable connection option comprises selecting the connection option which achieves the maximum data throughput.

18. The method as claimed in claim 14 wherein an identification process and data storage are carried out before logging on a connection with an access point.

19. The method as claimed in claim 14 wherein an identification process and data storage are carried out while a connection exists to an access point.

20. The method as claimed in claim 19 wherein before the identification process is carried out, a current access point is signaled that the mobile station cannot receive data for an agreed time, and arriving data is buffered in the current access point.

21. The method as claimed in claim 19, wherein the mobile station logs off the current access point which is carrying out the identification process, before the identification process is carried out, and wherein the mobile station logs on with the same access point or with another access point after the completion of the identification process.

22. The method as claimed in claim 14 wherein the automatic identification and the data storage and updating processes are carried out within a time period in which no data is transmitted and during which the mobile station is not busy carrying out other processes that cannot be interrupted.

23. The method as claimed in claim 14 wherein the identification and the data storage and updating connection option processes are carried out periodically.

24. The method of claim 14 wherein the identification of usable connection options is carried out by transmission of a signal to possible access points and by evaluation of the received signal or just by evaluation of the received signal.

25. The method of claim 14 wherein the identification of usable connection options is carried out in a data transmission pause during an active connection to an access point.

26. The method of claim 14 wherein in the event of a deterioration in the transmission quality or a connection failure to the current access point, after accessing the stored data or another identification process, a connection change is made to an access point which ensures a better transmission quality.

27. The method of claim 14 wherein switching to different standards and frequency bands is carried out under program control or by rebooting a processor.

28. The method of claim 14 further comprising:
carrying out a periodic comparison between the connection parameters to the current access point and other connection options; and
making a change to another connection option automatically or manually.
